(19) United States
(12) Patent Application Publication
(10) Pub. No.: US 2015/0088465 A1
(43) Pub. Date: Mar. 26, 2015

(54) CAD SYSTEM WITH AUXILIARY INPUT SYSTEM

(71) Applicant: Siemens Product Lifecycle Management Software Inc., Plano, TX (US)

(72) Inventors: Thomas James Buchanan, Vizcaya (ES); Daren Rhoades, Laguna Hills, CA (US); Kenneth Hosch, Redondo Beach, CA (US)

(73) Assignee: Siemens Product Lifecycle Management Software Inc., Plano, TX (US)

(21) Appl. No.: 14/037,561

(22) Filed: Sep. 26, 2013

(51) Int. Cl. G06F 17/50; G06T 17/00

(52) U.S. Cl. CPC G06F 17/50; G06T 17/00
USPC 703/1

(57) ABSTRACT

Methods for CAD editing and corresponding systems and computer-readable mediums. A method for CAD editing includes receiving executing a CAD modeling session by a CAD data processing system. The method includes communicating between the CAD data processing system and an auxiliary device and sending a geometry package from the CAD data processing system to the auxiliary device. The method includes receiving user input by the auxiliary device and transmitting user input data, corresponding to the user input, from the auxiliary device to the CAD data processing system. The method includes updating the CAD modeling session, by the CAD data processing system, according to the user input data. The user input can be, for example, touch-screen input or stylus input on the display of the auxiliary device.

### TECHNICAL FIELD

The present disclosure is directed, in general, to computer-aided design, engineering, visualization, authoring, and manufacturing systems (all referred to as “CAD systems”), product lifecycle management (“PLM”) systems, and similar systems, that manage data for products and other items (collectively, “Product Data Management” systems or PDM systems).

### BACKGROUND OF THE DISCLOSURE

PDM systems manage PLM and other data and CAD systems aid in the creation, management, and use of two-dimensional (2D) and three-dimensional (3D) models. Improved systems are desirable.

### SUMMARY OF THE DISCLOSURE

Various disclosed embodiments include systems and methods for CAD editing. A method for CAD editing includes executing a CAD modeling session by a CAD data processing system. The method includes communicating between the CAD data processing system and an auxiliary device and sending a geometry package from the CAD data processing system to the auxiliary device. The method includes receiving user input by the auxiliary device and transmitting user input data, corresponding to the user input, from the auxiliary device to the CAD data processing system. The method includes updating the CAD modeling session, by the CAD data processing system, according to the user input data. The user input can be, for example, touch-screen input or stylus input on the display of the auxiliary device.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software, or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a block diagram of a data processing system in which an embodiment can be implemented;

FIG. 2 illustrates a dual-input CAD editing system in accordance with disclosed embodiments; and

FIG. 3 illustrates a flowchart of a process in accordance with disclosed embodiments.

### DETAILED DESCRIPTION

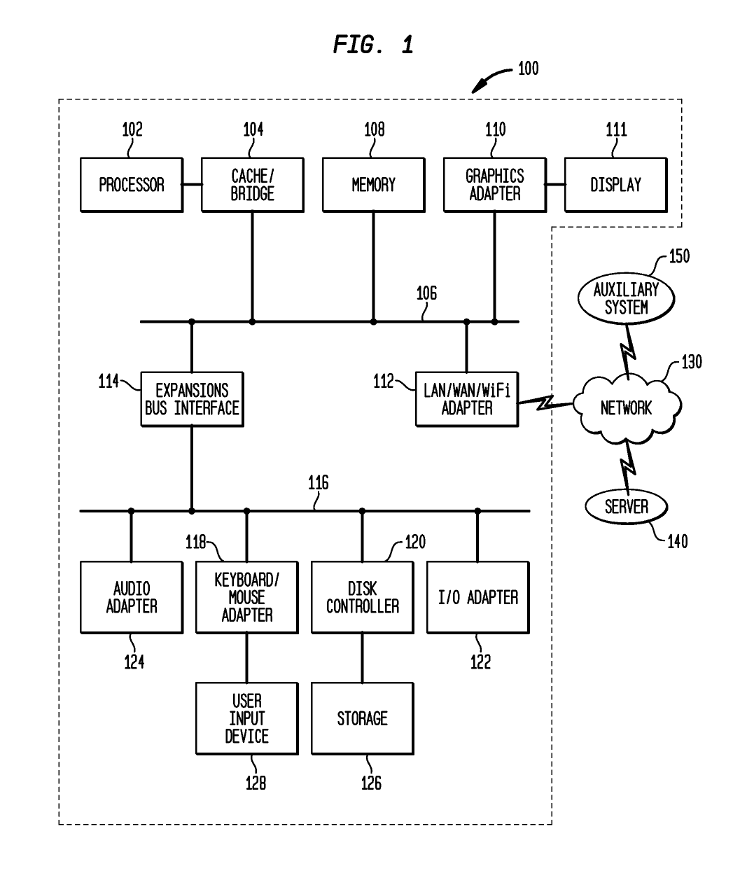

FIGS. 1 through 3, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Disclosed embodiments include systems and methods that enable creation and editing of CAD models on “auxiliary” systems or devices such as smartphones, tablet computers, and other systems, and in particular systems that may not be configured with the storage, memory, or processing power necessary to execute a conventional CAD software application. Disclosed embodiments include systems and methods that enable a user to draw on or otherwise interact with the auxiliary system to immediately produce corresponding edits on a corresponding CAD data processing system. For example, the user can interact with the auxiliary device to produce curves, markup, or digital ink in the context of a 3D geometry authoring application or other CAD application running on a CAD data processing system. The auxiliary device communicates with the CAD data processing system and its software, such as a 3D application session, to enable the auxiliary device to display background geometry to help the user draw. Curves that are created with, for example, touch and stylus input to a tablet computer are transmitted to the session of the 3D geometry application executing on the CAD data processing system, in either real time or at a later time.

The user's touch and stylus input can be interpreted by the auxiliary device and converted into geometry that the CAD data processing system understands. For example, a touch input to the auxiliary device of dragging a finger in a relatively straight line can produce “wobbly” ink on the auxiliary device, since the user input is rarely an accurate, straight line. The auxiliary device can fit a line “geometry” according the wobbly ink and send the corresponding line as the user input to the CAD session on the CAD data processing system. The underlying geometry on the auxiliary device can be used by the auxiliary device to “snap” the user input to an appropriate location, correct the user input so that it conforms to the underlying geometry, or otherwise modify the user's touch or stylus input so that it is correctly reflected in the CAD model. Disclosed embodiments can leverage mobile devices, such as tablet computers, smartphones, or touchscreen laptop computers that may already be commonly carried and used by engineers or designers, to act as the auxiliary device described herein.

FIG. 1 illustrates a block diagram of a data processing system in which an embodiment can be implemented, for example as a CAD system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a user input device 128, such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described. Both the data processing system and the auxiliary device described herein can be implemented using any operating system, including those for personal-computer type devices and those intended for tablet or mobile devices.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Data processing system can also communicate with an auxiliary system or device 150 as described herein, which itself can be implemented as a separate data processing system 100 or similar system, including in particular a tablet or laptop computer, a “smartphone” or other mobile computing device, a touchscreen display, or other system that can perform processes as described below. The communications between auxiliary device 150 and data processing system 100 can be, for example, over network 130, or can be through any other wired or wireless communication system, including WiFi® communications, Bluetooth® communications, serial or parallel wired communications, or otherwise.

Disclosed embodiments include systems and methods that allow a user to input 2D or 3D data into a 3D software session on a CAD data processing system via an auxiliary device such as a tablet computer or smartphone. The user can draw on the auxiliary device such as by using touch or a stylus.

In particular embodiments, the auxiliary device 150 can be and is preferably operated using touch or stylus input on its display, and the input system on such a display can function as the user input device 128. In various embodiments, the auxiliary device provides other capabilities not available on the main device; these can include creating digital ink, sketch recognition, handwriting recognition, digital painting, mathematical equation recognition, global positioning system technology, and other capabilities.

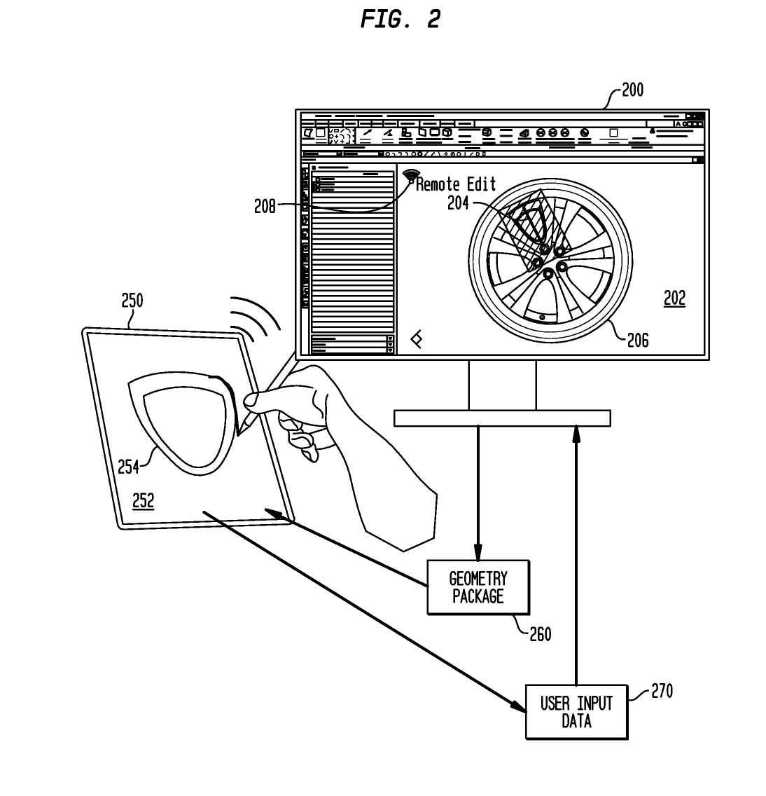

FIG. 2 illustrates a dual-input CAD editing system in accordance with disclosed embodiments. A CAD data processing system 200 is in communication with auxiliary device 250; suitable auxiliary devices 250 include but are not limited to tablet computers, smartphones, touchscreen laptop computers, and touchscreen displays. CAD data processing system 200 is executing a full CAD modeling application and interface in a CAD modeling session as illustrated at 202.

Auxiliary device 250 executes a simplified CAD interface 252 and corresponding CAD application. The auxiliary device and its application can perform processes as described herein, including sketch/input recognition and communications with the CAD data processing system. Simplified CAD interface 252 allows a user to interact with auxiliary device 250 to create or edit model portion 254, which corresponds to a portion 204 of the 3D model 206 in the full CAD modeling application 202; suitable full CAD modeling applications 202 include but are not limited to the Solid Edge® and NX® software products by Siemens Product Lifecycle Management Software Inc. CAD data processing system 200 can display an icon 208 or other indicator, including one or more visual or auditory indicator(s) that notifies a user that the CAD modeling application is in a “remote editing” mode and in communication with the auxiliary device 250.

In various embodiments, the CAD data processing system 200 and auxiliary device 250 may interrupt or cease communications, either intentionally (for example, when temporarily putting the auxiliary device 250 to sleep) or unintentionally (for example, when communication is lost or dropped from interference). In such cases, the communication may be re-established by either the CAD data processing system 200 or auxiliary device 250, manually or automatically, so that processes described herein can resume. Data processing system 200 and auxiliary device 250 can maintain their respective data until a successful transfer to the other system has been confirmed in order to avoid any potential loss of data.

According to disclosed embodiments, the CAD data processing system transmits data to the auxiliary device that corresponds to a portion or all of the CAD model so that the auxiliary device can display a model portion to the user. This data can be a geometry package 260 as described herein. Geometry package 260 can be implemented as a JT-format file developed by Siemens Product Lifecycle Management Software Inc., ISO 10303-compliant data, or otherwise.

Disclosed embodiments receive a user input on the auxiliary device, transmit a corresponding signal to the CAD data processing system, and perform a corresponding edit or other action to a CAD model on the CAD data processing system. This signal is generally represented as the user input data 270 described herein.

The type of user input that can be processed in this manner can include, but is not limited to curve geometry such as lines, arcs, circles, ellipses, conics, and splines, text, dimensions, equations, and other “digital ink” drawing or input.

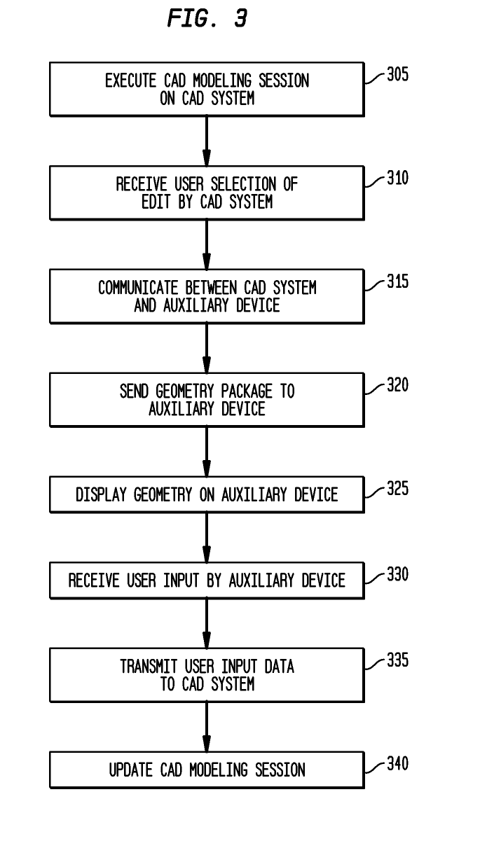

FIG. 3 illustrates flowchart of a process in accordance with disclosed embodiments that can be performed by a CAD data processing system and auxiliary device as described herein.

The CAD data processing system, such as CAD data processing system 200, executes a CAD modeling session (305). “CAD” is intended to refer broadly to any computer-aided design, engineering, visualization, authoring, or manufacturing system or data.

The CAD data processing system can receive a user input that specifies a plane or location within 3D space where the user desires to create or edit 2D or 3D data (310).

The CAD data processing system communicates with the auxiliary device (315), such as auxiliary device 250. This can be performed in response to receiving a user command to being a remote editing session. In other cases, initiating the connection between the two devices can be performed in other ways, such as by pointing the a camera of the auxiliary device at the CAD session and having it register a QR code or even interpret the geometry displayed in the CAD session and respond by communicating between the auxiliary device and the CAD data processing system. Such communications can be by technologies such as HTML, live streaming, or others known to those of skill in the art.

The CAD data processing system sends, to the auxiliary device, a geometry package of data describing the plane and any existing curves or peripheral geometry the user needs to sketch (320). As part of this initiation process, the auxiliary device can display a notification on the secondary device informing a user that a remote editing session is pending, and can receive a user confirmation that the remote editing session is accepted. The geometry package can be CAD-form geometries, including background geometries, or can be a fixed image form of the geometries relevant to the user. The geometry package can include a plane definition. The geometry package can represent a portion of the geometry of the CAD modeling session.

In certain “offline operation” cases, the auxiliary device may temporarily cease communication with the CAD data processing system at this point, allowing the user to interact with and edit geometry using the auxiliary device even while not currently connected to the CAD data processing system. This allows the user to perform edits at a remote location, when the devices are not connected, using the auxiliary device.

The auxiliary device can display any existing curves, peripheral geometry, or other geometry in the geometry package (325). These can be displayed as background objects or geometry.

The auxiliary device receives a user input (330). The user input is a CAD operation or input. For example, the user is able to draw “ink” as a user input on the secondary device using touch or stylus input. The auxiliary device can recognize the user input as curves (line, arc, ellipse, spline, etc.), text, dimensions or other object type. The background objects can be used to help the user construct curves, both as visual guides or by the auxiliary device “snapping” or automatically positioning the new curves with respect to the existing geometry using geometric constraints. The user display and input on the auxiliary device can be 2D or 3D.

In various embodiments, there is a separate application running on the auxiliary device, such as a simplified CAD application, that is independent of the CAD application running on the CAD data processing system. As part of receiving the user input, the auxiliary device can create geometry from touch/stylus user input, such as by converting the “ink” user input to curves that can be integrated with the CAD model or geometry by either the simplified CAD application on the auxiliary device or by the CAD modeling session on the CAD data processing system.

The auxiliary device transmits user input data, corresponding to the user input, to the CAD data processing system (335). For example, the auxiliary device can recognize 2D data and transmit it back to the CAD modeling session on the CAD data processing system. This process can be performed “live” as the user creates the user input, or can be sent when the user indicates they have finished an editing task on the auxiliary device.

In “offline operation” cases, this transmission from the auxiliary device to the CAD data processing system may be delayed until communication is re-established between the devices, for example when the user returns from performing edits at a remote location.

The CAD data processing system updates the CAD modeling session according to the user input data (340). This can include storing the CAD model and can include transmitting, to the auxiliary device, an updated geometry package that corresponds to the updated CAD modeling session. In particular embodiments, where the user input was in 2D, the CAD data processing system can convert the 2D user input to 3D geometries when updating the CAD modeling session.

One or more of these steps can be repeated as needed, and can be performed continuously, so that the user is provided an interactive CAD editing experience on the auxiliary device, even when the auxiliary device does not have the hardware, software, or data to execute the CAD modeling session independently.

Of course, those of skill in the art will recognize that, unless specifically indicated or required by the sequence of operations, certain steps in the processes described above may be omitted, performed concurrently or sequentially, or performed in a different order. For example, in cases where the user is resuming editing of a model on the auxiliary device, it may not be necessary to re-send any geometry package from the CAD data processing system. As another example, receiving user inputs and transmitting them to the CAD data processing system may be performed repeatedly for each geometry package or for each user input that specifies a plane or location within 3D space where the user desires to create or edit 2D or 3D data.

Various embodiments can be implemented differently within the scope of the disclosure. For example, various embodiments allow the user to create/modify sketches/curves/wireframe within a CAD session running on the CAD data processing system using ink on the display of an auxiliary computer.

Some embodiments could use a remote-access-type technology to push the display from the CAD data processing system to the auxiliary device. Ink and gesture inputs can then be transmitted to desktop from the auxiliary device; the CAD system can execute a curve recognition process to capture the curves in the CAD session. In some such embodiments, display image data is sent from the CAD data processing system to the auxiliary device instead of the geometry package described above. In such cases, the auxiliary device can be limited to only transmitting the input information back to the main device, with little or no local processing, which interprets the input as geometry and finally updates the display on the tablet.

In some embodiments, a “snapshot” of known orientation and scale is taken in the CAD data processing system session and sent as an image to the auxiliary device. The snapshot is used as a visual guide for the user to ink over on the auxiliary device. The orientation and location of the recognized curves are known relative to the plane of the snapshot. The user issues a send command and the curves appear in the CAD data processing system session in the correct location with the correct scale.

In some embodiments, curve geometry can be sent back and forth between CAD data processing system and an auxiliary device app. Various processes can include selecting reference geometry in the CAD application on the CAD data processing device, which is sent to the auxiliary device. On the auxiliary device, reference curves are then used to aid curves created by recognizing ink or other user input. Completed curves can then be sent back to the CAD data processing system. In some cases, an existing sketch can be sent to the auxiliary device, which receives user edits and sends an updated sketch back to the CAD data processing system. In some cases, the CAD data processing system can store the user-entered “ink” in a CAD part file for editing.

In still other embodiments, the auxiliary device executes a CAD application. From the auxiliary device, the user interface and display is sent to CAD data processing system monitor via cable or wireless display technology. A second display of a CAD model can be presented on auxiliary device, and the user can manipulate the CAD model via auxiliary or desktop display. Curves created and edited using ink are directly converted to CAD curves.

In some embodiments, when in a curve create/edit state in the CAD application, the user is provided with an option to perform the task using the auxiliary device. The system can allow the user to specify which auxiliary device they want to link to either at the time the option is exercised or by preset preferences.

In some embodiments, the auxiliary device can receive user inputs to launch curve create/edit capability to connect to the CAD data processing system. CAD data processing system session can allow the user to accept/reject the request.

In some embodiments, the user can point the auxiliary device camera at the CAD data processing system scene. The auxiliary device can recognize the context of the CAD session, via QR code or otherwise, and transmit/receive the info needed to create/edit curves.

Various embodiments can ensure secure communication between CAD data processing system and the auxiliary device. This can be implemented using encryption, generated security codes or passwords, secure device identifiers, or otherwise.

In some cases, the curve create/edit functions will show a representation of the auxiliary device in the scene. The user will be able to manipulate the location and orientation of the auxiliary device. The display within the auxiliary device will update as necessary, for example using the accelerometer technology in the auxiliary device.

Similarly, in some cases, the user can manipulate the plane of the sketch using commands on the auxiliary device or by re-orienting the auxiliary device.

In some cases, multiple candidate sets of 2D data or geometry packages may be stored and managed by the auxiliary device. The auxiliary system can send a single set of data, or any combination of data, to CAD modeling session for comparison studies. The auxiliary device or the CAD data processing system can allow the user to select alternate sets of data, identify the active and alternate sets of data, and compare sets of 2D data side-by-side in the context of the 3D host session.

In other embodiments, the CAD data processing system can concurrently or sequentially interact with a plurality of users and a plurality of auxiliary devices. Each of the users and auxiliary devices can access the same CAD session to work concurrently on the same product design.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 or auxiliary device 150 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method, comprising:
executing a computer-aided design (CAD) modeling session by a CAD data processing system;
communicating between the CAD data processing system and an auxiliary device;
sending a geometry package from the CAD data processing system to the auxiliary device;
receiving user input by the auxiliary device;
transmitting user input data, corresponding to the user input, from the auxiliary device to the CAD data processing system; and
updating the CAD modeling session, by the CAD data processing system, according to the user input data.

2. The method of claim 1, wherein the auxiliary device is one of a tablet computer or a smartphone.

3. The method of claim 1, wherein the auxiliary device has a touch-screen display, and the user input is touch input or stylus input on the touch-screen display.

4. The method of claim 1, wherein the geometry package includes background geometries and a plane definition.

5. The method of claim 1, wherein the user input is one of curves, text, or dimensions.

6. The method of claim 1, wherein the user input data is transmitted to the CAD data processing system as the auxiliary device receives the user input.

7. The method of claim 1, wherein the CAD data processing system sends, to the auxiliary device, an updated geometry package that corresponds to the updated CAD modeling session.

8. The method of claim 1, wherein the geometry package represents a portion of the geometry of the CAD modeling session.

9. The method of claim 1, wherein the auxiliary device automatically positions the user input using geometric constraints.

10. The method of claim 1, wherein the user input is two-dimensional, and the CAD data processing system converts the user input to three-dimensional geometries when updating the CAD modeling session.

11. A dual-input computer-aided design (CAD) editing system, comprising:
a CAD data processing system having a processor and an accessible memory; and
an auxiliary device having a display and user input device, the dual-input CAD editing system configured to:
execute a CAD modeling session by the CAD data processing system;
communicate between the CAD data processing system and the auxiliary device;
send a geometry package from the CAD data processing system to the auxiliary device;
receive user input by the auxiliary device;
transmit user input data, corresponding to the user input, from the auxiliary device to the CAD data processing system; and
update the CAD modeling session, by the CAD data processing system, according to the user input data.

12. The dual-input CAD editing system of claim 11, wherein the auxiliary device is one of a tablet computer or a smartphone.

13. The dual-input CAD editing system of claim 11, wherein the auxiliary device has a touch-screen display, and the user input is touch input or stylus input on the touch-screen display.

14. The dual-input CAD editing system of claim 11, wherein the geometry package includes background geometries and a plane definition.

15. The dual-input CAD editing system of claim 11, wherein the user input is one of curves, text, or dimensions.

16. The dual-input CAD editing system of claim 11, wherein the user input data is transmitted to the CAD data processing system as the auxiliary device receives the user input.

17. The dual-input CAD editing system of claim 11, wherein the CAD data processing system sends, to the auxiliary device, an updated geometry package (260) that corresponds to the updated CAD modeling session.

18. The dual-input CAD editing system of claim 11, wherein the geometry package represents a portion (254) of the geometry of the CAD modeling session.

19. The dual-input CAD editing system of claim 11, wherein the auxiliary device automatically positions the user input using geometric constraints.

20. The dual-input CAD editing system of claim 11, wherein the user input is two-dimensional, and the CAD data processing system converts the user input to three-dimensional geometries when updating the CAD modeling session.
